(19) United States
(12) Patent Application Publication
(10) Pub. No.: US 2023/0186131 A1
(43) Pub. Date: Jun. 15, 2023

(54) SIMULATOR FOR QUANTUM COMPUTING SYSTEMS

(71) Applicant: QULABZ INC., Kendall Park, NJ (US)

(72) Inventors: Nixon PATEL, Kendall Park, NJ (US); Goutam Kumar PAUL, Kolkata (IN); Kaushik NANDI, Kolkata (IN); Karthik KRISHNAKUMAR, Hyderabad (IN)

(21) Appl. No.: 17/993,697

(22) Filed: Nov. 23, 2022

(30) Foreign Application Priority Data
Nov. 24, 2021 (IN) 202131054345

(51) Int. Cl. G06N 10/20

(52) U.S. Cl. CPC G06N 10/20

(57) ABSTRACT

Techniques for providing a simulator for quantum computing systems are described. In operation, a gate teleportation circuit for a predetermined number of qubits is obtained, where the gate teleportation circuit is complaint with Measurement Based Quantum Computing model of quantum computing. Thereafter, segmentation of the gate teleportation circuit into multiple sub-circuits is simulated. A gate teleportation operation is then simulated on each of the multiple sub-circuits, where the gate teleportation operation on each of the multiple sub-circuits is simulated based on the at least one qubit of a given sub-circuit and an output of a gate teleportation operation performed on a sub-circuit which is previous to the given sub-circuit. An output of the gate teleportation operation simulated on the last sub-circuit from the multiple sub-circuits is then measured.

### BACKGROUND

Quantum computing involves utilization of principles of quantum mechanics to perform complex computations. Devices that perform computations in quantum computing are known as quantum computing systems.

Quantum computing systems operate on quantum bits (or qubits) for manipulating information in quantum computing. A qubit is a basic building block for quantum information processing. The qubits are two-level quantum systems that are used to store and process quantum information. The qubits exist in superposition, i.e., the qubits can exist in two states simultaneously, thereby providing inherent parallelism in quantum computing.

A quantum computing system generally has three components which include an area for housing the qubits, a method for transferring signal to the qubits, and a classical computing system to send instructions. Generally, the area for housing the qubits is kept at a temperature around absolute zero to maximize the coherence of the qubits and reduce interference. Further, signals are sent to the qubits using a variety of methods, such as microwaves or laser.

### BRIEF DESCRIPTION OF DRAWINGS

FIG. 1 illustrates schematic of a simulator for quantum computing systems, in accordance with an example of the present subject matter,

FIG. 2 illustrates schematic of the simulator for the quantum computing systems, in accordance with another example of the present subject matter,

FIG. 3 illustrates a gate teleportation circuit a gate teleportation circuit prepared in accordance with an example of the present subject matter,

FIG. 4 illustrate a segmented gate teleportation circuit prepared in accordance with an example of the present subject matter, and

FIG. 5 illustrates a method for implementing the simulator for quantum computing systems, in accordance with an example of the present subject matter.

FIG. 6 illustrates a method for implementing a simulator for quantum computing systems, in accordance with examples of the present subject matter

### DETAILED DESCRIPTION

Quantum computing systems are known to be highly sensitive to external factors such as, heat and electromagnetic fields. For instance, while a quantum computing system is in operation, collision of qubits with air molecules may cause a qubit to lose its quantum properties, which in turn may cause the quantum computing system to malfunction. The probability of malfunctioning of the quantum computing device increases with the number of the qubits involved in the operation. Accordingly, setting up of the quantum computing systems entails availability of highly controlled environments with respect to the various different factors, thereby rendering such set ups highly difficult and expensive.

To alleviate such problems associated with the quantum computing systems, simulators for quantum computing systems have been developed. Simulators for quantum computing systems operate on classical computing systems while providing the functionalities provided by the quantum computing systems, thereby addressing the problems related to cost and complexity associated with setting up of the quantum computing systems. Further, like the quantum computing systems, such simulators also utilize various quantum computing models that operate on qubits for experimental realisations of quantum information processors. The quantum computing models utilize various quantum gates to manipulate information.

The quantum gates act on qubits to alter the state of the qubit, where the alteration of the state of qubit generally corresponds to the rotation of the qubits in Bloch Sphere. The Bloch sphere is a geometric representation of qubit states as points on the surface of a unit sphere. There are certain criteria that a quantum gate must satisfy to be a valid operation, one of which is that the quantum gate must be a unitary matrices to ensure that the modulus of the qubit does not change. For the purpose of understanding, the quantum gates can be understood to be analogous to logic gates in classical computers as the quantum gates operate in a similar manner to gates, such as the ‘NOT’, ‘AND’, and ‘OR’ gates, operate in classical computers.

Quantum gates are primarily classified into two categories, i.e., single qubit gates and multi-qubit gates. An example of single qubit gate is Pauli gate. There are three Pauli Gates, i.e., X, Y, and Z, where each of the Pauli gates X, Y, Z correspond to the measurement operators in each of the basis directions respectively. A Pauli gate along with identity gate provides a generator of all possible operations on a single qubit. The matrix representations and circuit representations of the Pauli gates X, Y, and Z are provided in the Table 1:

TABLE 1

| | | | |
|---|---|---|---|
| Pauli-X (X) | 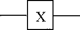 | 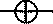 | $\left[\begin{matrix}0 & 1 \\ 1 & 0\end{matrix}\right]$ |
| Pauli- Y (Y) | 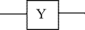 | | $\left[\begin{matrix}0 & - i \\ i & 0\end{matrix}\right]$ |
| Pauli-Z (Z) | 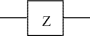 | | $\left[\begin{matrix}1 & 0 \\ 0 & - 1\end{matrix}\right]$ |

Another example of single qubit gate is a Hadamard gate. The Hadamard gate acts as a transformation from Z-computational basis to X-computational basis and vice versa. Hadamard gates are particularly important for several quantum techniques as when Hadamard gates are acted on multiple qubits, an equal superposition of all basis states is obtained. An action of the Hadamard gate on the basis states and a matrix representation of the same is in the Table 2:

TABLE 2

| | | |
|---|---|---|
| | $H \left\|0\right〉 \to \frac{\left\|0\right〉 + \left\|1\right〉}{2}$ | |
| | $H \left\|1\right〉 \to \frac{\left\|0\right〉 - \left\|1\right〉}{2}$ | |
| Hadamard (H) | 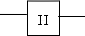 | $\frac{1}{\sqrt{2}} \left[\begin{matrix}1 & 1 \\ 1 & - 1\end{matrix}\right]$ |

Single qubit Gates are not sufficient to implement all possible actions on a system of qubits. Thus, similar to 2-bit logical gates in classical computing, such as AND gates and OR gates, there exists multi-qubit gates in quantum computing. An example of multi-qubit gate is a Controlled-Not gate. In the controlled Not gate, one qubit acts as a control qubit and the other qubit acts as a target qubit. The action on the target qubit is conditional on the state in the control qubit. If the Control Qubit is in state |0〉, then there exists no action on the target qubit and if the target qubit is in the state |1〉 then a X Pauli operation is performed on the target qubit. The Controlled-Not gate along with the Pauli gates forms a Universal Gate Set.

Another example of the multi-qubit gate are Swap gates and Toffoli gates. The Swap gate exchanges the state between two wires in a circuit and the Toffoli gate acts as a controlled swap gate similar to the Controlled Not gate. The matrix representations of the Controlled-Not gate, swap gate, and the Toffoli gate are provided in Table 3:

TABLE 3

| | | | |
|---|---|---|---|
| Controlled Not (CNOT, CX) | | 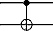 | $\left[\begin{matrix}1 & 0 & 0 & 0 \\ 0 & 1 & 0 & 0 \\ 0 & 0 & 0 & 1 \\ 0 & 0 & 1 & 0\end{matrix}\right]$ |
| SWAP | 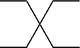 | 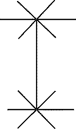 | $\left[\begin{matrix}1 & 0 & 0 & 0 \\ 0 & 0 & 1 & 0 \\ 0 & 1 & 0 & 0 \\ 0 & 0 & 0 & 1\end{matrix}\right]$ |
| Toffoli (CCNOT, CCX, TOFF) | 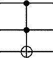 | | $\left[\begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 0 & 1 \\ 0 & 0 & 0 & 0 & 0 & 0 & 1 & 0\end{matrix}\right]$ |

One of the quantum computing models based on which the known simulators operate is circuit model. In the circuit model of quantum computing, a number of qubits initialized in the |0〉 state, are taken as the input state. The qubits are then allowed to undergo various one-qubit and two qubit operations before being measured. Usually, quantum computation in circuit model represents unitary operations which can be decomposed into controlled-NOT gates and single qubit unitary (more specifically, special unitary gates, SU(2)) gates. However, in the circuit model of quantum computing, the number of the unitary gates required for a given quantum operation grows exponentially with the circuit. This in turn exponentially increases the consumption of computational resources when the simulators based on the circuit model executes on the classical computing systems.

Accordingly, quantum computing models other than the circuit model are being utilized to develop simulators for quantum computing systems. One of the alternatives of the circuit model for development of the simulators is Measurement Based Quantum Computing (MBQC) model.

In the MBQC model, the initial state preparation for MBQC is based on the concept of gate teleportation. The gate teleportation circuit facilitates transfer of an unknown quantum state to another qubit in the MBQC model. In the MBQC model, performing the gate teleportation involves supplying all the qubits involved in computation in a highly entangled state, also known as cluster state. The highly entangled state is prepared by applying a pattern of entangling gates, such as a controlled Z-(CZ) gate, to the qubits.

One of the approaches for development of simulators based on the MBQC model involve moving all the entanglement operations to initialization of a MBQC circuit and sequentially performing measurements and operations to ensure correctness of the MBQC model. Various aspects are considered while developing the simulator for the MBQC model, such as implementation of Pauli corrections. There are two ways to correct the Pauli corrections that appear as part of the MBQC circuit. These corrections are twofold, where one is X corrections appearing due to the teleportation circuit while other is Z corrections appearing due to the commutation occurring between the CZ gates and the X corrections. The X corrections and CZ corrections are dependent on the measurement outcomes of a previous layer in the MBQC circuit. There are a number of ways to implement the X corrections and CZ corrections. One of the ways to implement the X corrections and CZ corrections involves explicitly correcting the Pauli error caused at the end of every measurement cycle. The other way to implement the X corrections and CZ corrections involves altering the forthcoming rotation angles to take into consideration the previous measurements and implicitly correcting the errors.

While the simulators developed based on the above-mentioned approaches work well on smaller number of MBQC inputs, i.e., lesser number of qubits or lesser number of MBQC graph states, memory requirements for such a computation increases exponentially with an increase in the number of qubits or MBQC graph states.

The exponential increase in the memory requirement may be attributed to different reasons. For instance, as the size of the graph state to be implemented goes up, the dimension of each operation in the circuit goes up exponentially. The increase in dimensionality also severely effects the time complexity of the program as the matrix operations are already computationally tedious tasks.

Further, creation and manipulation of quantum programs and running such programs on the quantum computing devices or simulators for quantum computing devices involves utilization of Qiskit. Qiskit is an open-source software development kit (SDK) for working with quantum computers at the level of circuits, pulses, and algorithms. Qiskit does not allows resetting previously used qubits to be used again for forthcoming layers, thereby leaving the old qubits as part of the operation even though they do not serve any computational purpose.

According to example implementations of the present subject matter, techniques for providing a simulator for quantum computing systems are described.

In an example, the techniques involve conceding on the demands of having a highly pre-entangled state of qubits and performing the gate teleportation operations sequentially.

In an example implementation, a gate teleportation circuit for a predetermined number of qubits may be obtained. In an example, the gate teleportation circuit for the qubits may be complaint with Measurement Based Quantum Computing (MBQC) model of quantum computing. The simulator may then simulate segmentation of the gate teleportation circuit into multiple sub-circuits to process the qubits sequentially.

In an example, the simulator may simulate segmentation of the gate teleportation circuit into multiple sub-circuits based on the predetermined number of qubits included in the gate teleportation circuit. Subsequently, the simulator may simulate a gate teleportation operation for a first sub-circuit from the multiple sub-circuits and an output of the first sub-circuit may be inputted to a forthcoming subcircuit, i.e., a second sub-circuit of the multiple sub-circuits. The process of simulation of the gate teleportation operation for a sub-circuit from the multiple sub-circuits and inputting the output of the gate teleportation operation on the sub-circuit to a forthcoming sub-circuit may be repeated until all the sub-circuits have been traversed. An output of the simulation for the last sub-circuit of the multiple sub-circuits may then be measured.

Segmenting the gate teleportation circuit for qubits into multiple sub-circuits and simulating the gate teleportation operations on the multiple sub-circuits sequentially reduces the computational complexity involved in preparation of the entangled state of all the involved qubits, thereby reducing the consumption of computational resources involved in execution of the simulator for quantum computing systems on classical computing systems.

Further, as output for each of the multiple sub-circuits is fed into forthcoming sub-circuits as soon as gate teleportation operation is complete for each of the multiple sub-circuits, duration for which qubits are to be maintained in their states is also reduced, thereby further reducing the consumption of computational resources. Moreover, simulation of the gate teleportation operations sequentially entails only a subset of total qubits involved in computation to be used at once, thereby allowing efficient usage of qubits.

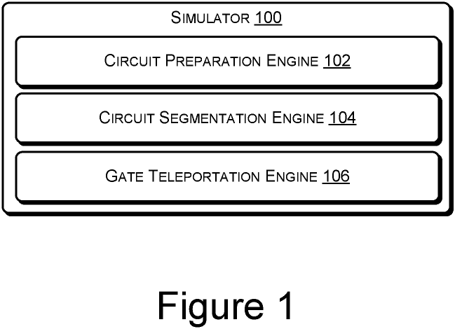

The above techniques are further described with reference to FIG. 1 to FIG. 5. It should be noted that the description and the figures merely illustrate the principles of the present subject matter along with examples described herein and should not be construed as a limitation to the present subject matter. It is thus understood that various arrangements may be devised that although not explicitly described or shown herein, statements herein reciting principles, aspects, and implementations of the present subject matter, as well as specific examples thereof, are intended to encompass equivalents thereof.

FIG. 1 illustrates schematic of a simulator 100 for quantum computing systems, in accordance with an example of the present subject matter. In an example, the simulator 100 may be implemented as a standalone hardware unit. In another example, the simulator 100 may be implemented as an application executable on a classical computing system.

In an example implementation of the present subject matter, the simulator 100 may include a circuit reception engine 102 for obtaining a gate teleportation circuit for a predetermined number of qubits. In said example, the gate teleportation circuit may be complaint with Measurement Based Quantum Computing (MBQC) model of quantum computing.

The simulator 100 may further include a circuit segmentation engine 104 for simulating segmentation of the gate teleportation circuit into multiple sub-circuits to process the qubits sequentially. In an example, the circuit segmentation engine 104 may simulate segmentation of the gate teleportation circuit based on the predetermined number of qubits included in the gate teleportation circuit.

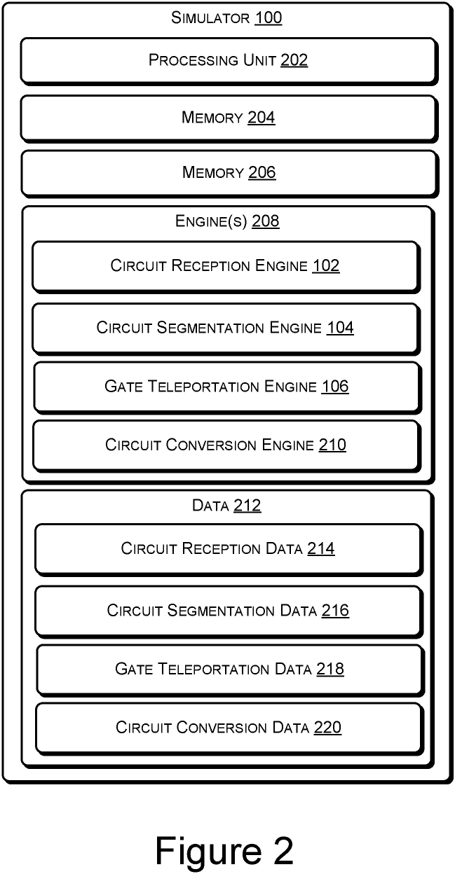

The gate teleportation engine 106 may then simulate a gate teleportation operation on a first sub-circuit of the multiple sub-circuits and obtain a first output. Thereafter, the gate teleportation engine 106 may input the first output into a second sub-circuit of the multiple sub-circuits. The gate teleportation engine 106 may subsequently simulate another gate teleportation operation on the second sub-circuit based on the input received from the first sub-circuit, i.e., first output, and the qubits included in the second sub-circuit. The gate teleportation engine 106 may similarly simulate the gate teleportation operations on rest of the sub-circuits till all the sub-circuits obtained from the segmentation of the gate teleportation circuit are traversed. The gate teleportation engine 106 may then measure a final output of simulation performed on the last teleportation circuit. The manner of implementation of the simulator 100 for the quantum computing systems is described in detail in conjunction with FIG. 2.

FIG. 2 illustrates schematic of the simulator 100 for quantum computing systems, in accordance with another example of the present subject matter. As already described, the simulator 100 may either be implemented as a standalone hardware unit or as an application executable on a classical computing system.

The simulator 100 may include a processor 202 and a memory 204 coupled to the processor 202. The functions of functional block labelled as “processor(s)”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM), non-volatile storage. Other hardware, standard and/or custom, may also be included.

The memory 204 may include any computer-readable medium including, for example, volatile memory (e.g., RAM), and/or non-volatile memory (e.g., EPROM, flash memory, etc.).

The interface 206 may allow the connection or coupling of the simulator 100 with one or more other devices, through a wired (e.g., Local Area Network, i.e., LAN) connection or through a wireless connection (e.g., Bluetooth®, WiFi). The interface 206 may also enable intercommunication between different logical as well as hardware components of the simulator 100.

The simulator 100 may further include engines 208, where the engines 208 may include the circuit reception engine 102, the circuit segmentation engine 104, the gate teleportation engine 106, and a circuit conversion engine 210. In an example, the engines 208 may be implemented as a combination of hardware and firmware. In examples described herein, such combinations of hardware and firmware may be implemented in several different ways. For example, the firmware for the engine may be processor executable instructions stored on a non-transitory machine-readable storage medium and the hardware for the engine may include a processing resource (for example, implemented as either a single processor or a combination of multiple processors), to execute such instructions.

In the present examples, the machine-readable storage medium may store instructions that, when executed by the processing resource, implement the functionalities of the engine. In such examples, the simulator 100 may include the machine-readable storage medium storing the instructions and the processing resource to execute the instructions. In other examples of the present subject matter, the machine-readable storage medium may be located at a different location but accessible to the simulator 100 and the processor 202.

The simulator 100 may further include data 212, that serves, amongst other things, as a repository for storing data that may be fetched, processed, received, or generated by the circuit reception engine 102, circuit segmentation engine 104, gate teleportation engine 106, and circuit conversion engine 210. The data 212 may include circuit reception data 214, circuit segmentation data 216, gate teleportation data 218, and circuit conversion data 220. In an example, the data 212 may be stored in the memory 204.

In an example, the circuit reception engine 102 may obtain the gate teleportation circuit for the predetermined number of qubits, where the gate teleportation engine may be compliant with MBQC model. The circuit reception engine 102 may then store the gate teleportation circuit in the circuit reception data 214. In another example, the circuit reception engine 102 may receive a quantum circuit for the predetermined number of qubits, where the quantum circuit may be complaint with circuit model of quantum computing. The circuit conversion engine 210 may then convert the quantum circuit into the gate teleportation circuit and provide the gate teleportation circuit to the circuit reception engine 102. The circuit conversion engine 210 may convert the quantum circuit into the gate teleportation circuit in various ways.

For instance, in an example, the circuit conversion engine 210 may receive a quantum circuit as a QASM file, where the quantum circuit may be prepared in accordance with the circuit model. The circuit conversion engine 210 may then trans-compile the quantum circuit in accordance with a set of gates supported by the circuit conversion engine 210. The circuit conversion engine 210 may then generate a second QASM file corresponding to the trans-compiled quantum circuit.

The circuit conversion engine 210 may subsequently scan the second QASM file and parse instructions included in the second QASM file, to obtain a unitary matrix corresponding to each of the instructions. The circuit conversion engine 210 may then store the unitary matrix corresponding to each of the instructions along with the qubit(s) on which the circuit conversion engine 210 acted upon in circuit conversion data 214.

The circuit conversion engine 210 may then combine all single-qubit unitaries that acted consecutively on a qubit to yield an arbitrary single-qubit unitary that acts on that qubit. In an example, the circuit conversion engine 210 may combine the single-qubit unitaries based on matrix multiplication. The circuit conversion engine 210 may combine the single-qubit unitaries to ensure that only ‘4’ MBQC parameters are used for all the gates combined, thereby reducing the complexity and execution time of the MBQC model. The circuit conversion engine 210 may continue combining all consecutive single-qubit unitaries acting on a given qubit together until the circuit conversion engine 210 encounters a controlled unitary or a barrier on the qubit, indicating that optimization should be stopped.

The circuit conversion engine 210 may remove an instruction from the QASM file once the instruction is parsed. Further, after parsing the instruction, the circuit conversion engine 210 may obtain the MBQC parameters of the single-qubit unitary matrix stored for each qubit based on their Euler angles. The circuit conversion engine 210 may also ensure that all the qubits that have been acted upon by the unitary gates have the same number of parameters, in order to apply the identity operation on the other qubits that are not acted upon by any unitary or that are acted upon by an identity gate itself. The circuit conversion engine 210 may ensure that all the qubits that have been acted upon by the unitary gates have the same number of parameters by appending zeros, wherever necessary.

The circuit conversion engine 210 may parse controlled unitaries, i.e., the first gate encountered for each qubit, in a similar manner. The circuit conversion engine 210 may then obtain the MBQC parameters for the CU, if any, for each qubit as mentioned above and perform an identity operation on the left-out qubits.

The circuit conversion engine 210 may parse the remaining instructions until all instructions in the QASM file are processed in the manner described above and store the MBQC parameters in the circuit conversion data 220. In an example, the circuit conversion engine 210 may then access the MBQC parameters stored in the circuit conversion data 220 and prepare the gate teleportation circuit. The circuit conversion engine 210 may store the gate teleportation circuit in the circuit reception data 214.

The circuit segmentation engine 104 may then access the circuit reception data 214 and simulate the segmentation of the gate teleportation circuit into multiple sub-circuits to process the qubits sequentially. In an example, the circuit segmentation engine 104 may simulate segmentation of the gate teleportation circuit based on the predetermined number of qubits included in the gate teleportation circuit.

For instance, while simulating the segmentation of the gate teleportation circuit, the circuit segmentation engine 110 may determine the number of sub-circuits segmented from the gate teleportation circuit based on the predetermined number of qubits.

ln an example, if the predetermined number of qubits included in the gate teleportation circuit is equal to ‘2ⁿ’, the circuit segmentation engine 110 may simulate the segmentation of the gate teleportation circuit into multiple sub-circuits, where each of the multiple sub-circuits has ‘n’ qubits. For instance, if the number of qubits included in the gate teleportation circuit is ‘16’, the circuit segmentation engine 110 may simulate the segmentation of the gate teleportation circuit into multiple sub-circuits, with each of the multiple sub-circuit having ‘4’ qubits. Accordingly, if the number of qubits included in the gate teleportation circuit is ‘16’, the gate teleportation engine 110 may simulate the segmentation of the gate teleportation circuit into ‘4’ sub-circuits.

In another example, if the number of qubits included in the gate teleportation circuit is greater than ‘2ⁿ’ but less than 2ⁿ⁺¹, the circuit segmentation engine 110 may simulate segmentation of the gate teleportation circuit into multiple sub-circuits, where each of the multiple sub-circuits has ‘n+1’ qubits. For instance, if the number of qubits included in the gate teleportation circuit is ‘12’, the circuit segmentation engine 110 may simulate the segmentation of the gate teleportation circuit into multiple sub-circuits, with each of the multiple sub-circuits having ‘4’ qubits (since 2³<12<2⁴). Accordingly, for if the number of qubits included in the gate teleportation circuit is ‘16’, the gate teleportation engine 110 may simulate the segmentation of the gate teleportation circuit into ‘3’ sub-circuits.

The circuit segmentation engine 104 may then store the information related to multiple sub-circuits in the circuit segmentation data 216.

The gate teleportation engine 106 may then simulate a gate teleportation operation on a first sub-circuit of the ‘3’ sub-circuits and obtain a first output. The gate teleportation engine 106 may then store the first output in the gate teleportation data 218. Thereafter, the gate teleportation engine 106 may input the first output into a second sub-circuit of the ‘3’ sub-circuits. The gate teleportation engine 106 may subsequently simulate another gate teleportation operation on the second sub-circuit based on the input received from the first sub-circuit, i.e., first output, and the qubits included in the second sub-circuit and obtain a second output. Subsequently, the gate teleportation engine 106 may store the second output in the gate teleportation data 218.

The gate teleportation engine 106 may similarly simulate the gate teleportation operations for rest of the sub-circuits till all the sub-circuits obtained from the segmentation of the gate teleportation circuit are traversed. The gate teleportation engine 106 may then measure the final output from the last teleportation circuit and store the final output in the gate teleportation data 218.

In an example implementation, the simulator for the quantum computing system may be utilized for simulating Grover’s algorithm. The Grover’s Algorithm is a quantum algorithm that is utilized for performing a search on an unstructured database. In other words, the Grover’s algorithm may be utilized while a search is to be conducted for a particular item in a list of ‘N’ items placed in a scattered manner. To find the particular item in the list, most of the classical computing algorithms compare the particular item with every item in the list one after the other, which requires at least ‘N/2’ comparisons to find the particular item in the list. In worst case scenarios, the classical computing algorithms may end up comparing the particular item with all the ‘N’ items in the list. On the contrary, utilizing the Grover’s Algorithm on a quantum computing system, the particular item may be found in the list of ‘N’ items in roughly ‘√N’ comparisons.

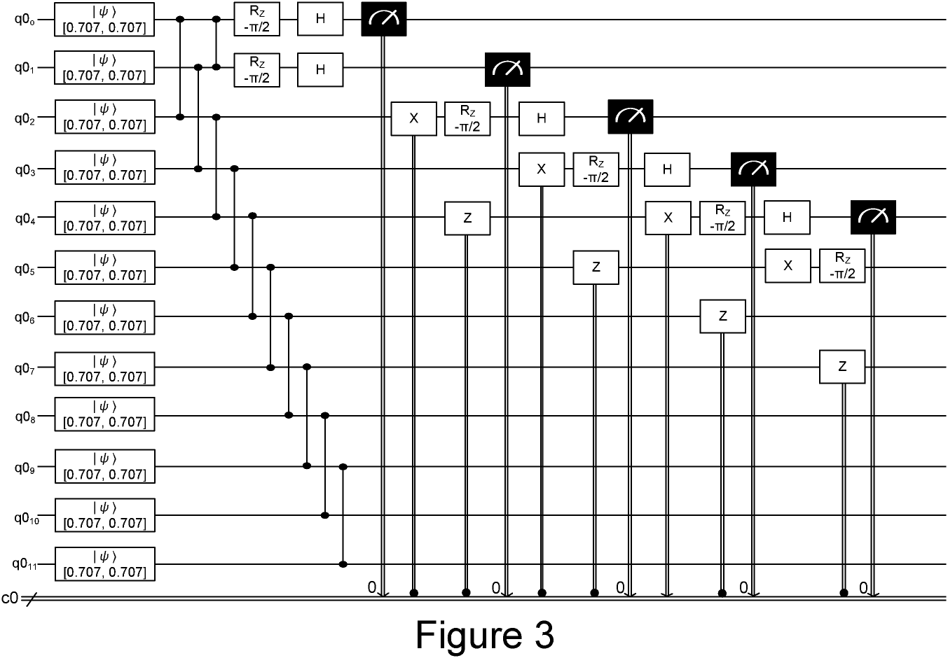

In an example of the present subject matter, the circuit reception engine 102 may simulate the Grover’s algorithm for ‘12’ qubits. In operation, the circuit reception engine 108 may obtain agate teleportation circuit for the ‘12’ qubits, where the gate teleportation circuit may be compliant with the MBQC model. In an example, instead of receiving the gate teleportation circuit, the circuit reception engine 108 may receive a quantum circuit for ‘12’ qubits, the quantum circuit being compliant with the circuit model. In the example, the circuit conversion engine 210 may convert the quantum circuit into the gate teleportation circuit and provide the same to the circuit reception engine 102. An exemplary gate teleportation circuit obtained by the circuit reception engine 108 for ‘12’ qubits is illustrated in FIG. 3. The ‘12’ qubits may include q0₀, q0₁, q0₂, q0₃, q0₄, q0₅, q0₆, q0₇, q0₈, q0₉, q0₁₀, and q0₁₁. In an example, each of the ‘12’ qubits may be operated upon by various quantum gates and a basis state for each qubit may be measured. In said example, the basis states for each of the qubits may be superimposed to obtain a final quantum state, where the quantum state may represent a solution to a quantum algorithm being operated upon by a quantum computing system.

Subsequently, the circuit segmentation engine 110 may simulate segmentation of the gate teleportation circuit into multiple sub-circuits. As already described, the circuit segmentation engine 110 may simulate segmentation of the gate teleportation circuit into multiple sub-circuits based on a number of qubits included in the gate teleportation circuit. Accordingly, the circuit segmentation engine 110 may simulate the segmentation of the gate teleportation circuit into ‘3’ sub-circuits, with each sub-circuit having ‘4’ qubits.

The gate teleportation engine 112 may then simulate a gate teleportation operation on a first sub-circuit of the ‘3’ sub-circuits and obtain a first output. In an example, the ‘4’ qubits included in the first sub-circuit may be q0₀, q0₁, q0₂, and q0₃, where the qubits q0₀ and q0₂ may be input qubits and q0₁ and q0₃ may be output qubits. In said example, to simulate the gate teleportation operation on the first sub-circuit, the gate teleportation engine 112 may begin with qubits q0₀, q0₁, q0₂, and q0₃ in the state |0>, thereby obtaining the state |Ψ0> = |0>|0>|0>|0>. Specifically, the gate teleportation engine 112 may begin with an empty circuit with all qubits initialized in the state ‘0’. A state vector corresponding to the above-mentioned state of qubits may be described by an array shown below:

$$\text{Statevector =} \left[\begin{matrix}1 & 0 & 0 & 0 & ⋯ & 0 & 0 & 0\end{matrix}\right]$$

Thereafter, the gate teleportation engine 112 may apply Hadamard operation on all the ‘4’ qubits to take the qubits to an equal superposition of all states in computational basis. The initial superposition of all the states so obtained may be described as follows:

$$\begin{matrix}\vert + > \vert + > \vert + > \vert + > = \\ \frac{1}{4} \left[\left(\vert 0 > + \vert 1 >\right) ∗ \left(\vert 0 > + \vert 1 >\right) ∗ \left(\vert 0 > + \vert 1 >\right) ∗ \left(\vert 0 > + \vert 1 >\right)\right]\end{matrix}$$

A state vector corresponding to the above-mentioned state of qubits may be described by an array shown below:

$$\text{Statevector =} \left[\begin{matrix}\frac{1}{4} & \frac{1}{4} & \frac{1}{4} & \frac{1}{4} & ⋯ & \frac{1}{4} & \frac{1}{4} & \frac{1}{4}\end{matrix}\right]$$

Thereafter, the gate teleportation engine 112 may apply CZ operations between the qubits q0₀ and q0₁. This, in turn, may lead to action of Z gate on the |1 >|0>, |1 >|1 > part of the state which leads to the -ve sign on amplitude corresponding to |1>|1>. The state so obtained may be described as follows:

$$\begin{matrix}\frac{1}{4} \left[\left(\vert 0 > \vert 0 > + \vert 0 > \vert 1 > + \vert 1 > \vert 0 > - \vert 1 > \vert 1 >\right) ∗\right) \\ \left(\left(\vert 0 > \vert 0 > + \vert 0 > \vert 1 > + \vert 1 > \vert 0 > + \vert 1 > \vert 1 >\right)\right]\end{matrix}$$

A state vector corresponding to the above-mentioned state of qubits may be described by an array shown below:

$$\begin{matrix}\text{Statevector =} \\ \left[\begin{matrix}\frac{1}{4} & \frac{1}{4} & \frac{1}{4} & - \frac{1}{4} & \frac{1}{4} & \frac{1}{4} & \frac{1}{4} & - \frac{1}{4} & \frac{1}{4} & \frac{1}{4} & \frac{1}{4} & - \frac{1}{4} & \frac{1}{4} & \frac{1}{4} & \frac{1}{4} & - \frac{1}{4}\end{matrix}\right]\end{matrix}$$

Subsequently, the gate teleportation engine 112 may apply CZ operations between the input qubits and output qubits. This may lead to addition of a -ve sign to the terms corresponding to the |1 >|1 >. Thus, an additional - ve sign may be seen added to the terms having q0q2 in |1 > 1 > state. Similarly, an additional - ve sign may also be added to the terms having q1q3 in |1>1> state. A state vector corresponding to the above-mentioned state of qubits may be described by an array shown below:

$$\begin{matrix}\text{Statevector =} \\ \left[\begin{matrix}\frac{1}{4} & \frac{1}{4} & \frac{1}{4} & - \frac{1}{4} & \frac{1}{4} & - \frac{1}{4} & \frac{1}{4} & \frac{1}{4} & \frac{1}{4} & \frac{1}{4} & - \frac{1}{4} & \frac{1}{4} & \frac{1}{4} & - \frac{1}{4} & - \frac{1}{4} & - \frac{1}{4}\end{matrix}\right]\end{matrix}$$

The gate teleportation engine 112 may then apply a -pi/2 rotation and Hadamard operator on the input qubits. This, in turn, may lead to the qubits going into the state described by array provided below:

$$\begin{matrix}\text{Statevector =} \\ \left[\begin{matrix}\frac{1}{4} \left(1 + i\right) & 0 & 0 & \frac{1}{4} \left(- 1 + i\right) & 0 & \frac{1}{4} \left(1 + i\right) & \frac{1}{4} \left(- 1 + i\right) & 0 & 0 & \frac{1}{4} \left(- 1 + i\right) & \frac{1}{4} \left(1 + i\right) & 0 & \frac{1}{4} \left(- 1 + i\right) & 0 & 0 & \frac{1}{4} \left(1 + i\right)\end{matrix}\right]\end{matrix}$$

The gate teleportation engine 112 may then perform the measurement of the input qubits q0₀ and q0₂ and apply corresponding corrections on the output qubits to receive a final state vector provided below

$$\begin{matrix}\text{Statevector =} \\ \left[\begin{matrix}\frac{1}{2} \left(1 + i\right) & 0 & 0 & 0 & 0 & 0 & 0 & 0 & 0 & 0 & 0 & 0 & \frac{1}{2} \left(- 1 + i\right) & 0 & 0 & 0\end{matrix}\right]\end{matrix}$$

The gate teleportation engine 112 may then decompose the above-mentioned state vector to get the following state:

$$\vert o u t p u t > = \left[\left(\vert 0 > \vert 0 >\right) ∗ \frac{1}{2} \left(\left\{1 + i\right\} \vert 00 > + \left\{- 1 + i\right\} \vert 11 >\right)\right)$$

The gate teleportation engine 112 may then input the first output, i.e., equation 2, into a second sub-circuit of the ‘3’ sub-circuits. The gate teleportation engine 112 may then simulate another gate teleportation operation on the second sub-circuit based on the input received from the first sub-circuit, i.e., first output, and the qubits included in the second sub-circuit, i.e., q0₄, q0₅, q0₆, and q0₇.

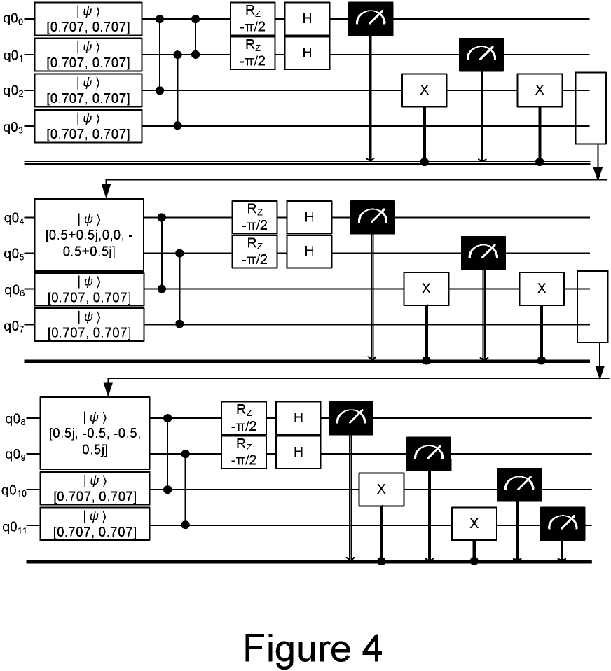

As illustrated in FIG. 4, the gate teleportation engine 112 may similarly simulate the gate teleportation operations on rest of the sub-circuits till all the sub-circuits obtained from the segmentation of the gate teleportation circuit are traversed. In an example, the gate teleportation engine 112 simulates the gate teleportation operation on the rest of the sub-circuits in a manner similar to the first sub-circuit. Accordingly, the details related to the manner in which the gate teleportation engine 112 simulates the gate teleportation operation on the rest of the sub-circuits is not described herein for the sake of brevity. The gate teleportation engine 112 may subsequently measure the final output from the last teleportation circuit.

Segmenting the gate teleportation circuit for qubits into multiple sub-circuits and simulating the gate teleportation operations on the multiple sub-circuits sequentially reduces the computational complexity involved in preparation of the entangled state of all the involved qubits, thereby reducing the consumption of computational resources involved in execution of the simulator for quantum computing systems on classical computing systems. Further, as output for each of the multiple sub-circuits is fed into forthcoming sub-circuits as soon as gate teleportation operation is complete for each of the multiple sub-circuits, duration for which qubits are to be maintained in their states is also reduced, thereby further reducing the consumption of computational resources. Moreover, simulation of the gate teleportation operations sequentially entails only a subset of total qubits involved in computation to be used at once, thereby allowing efficient usage of qubits.

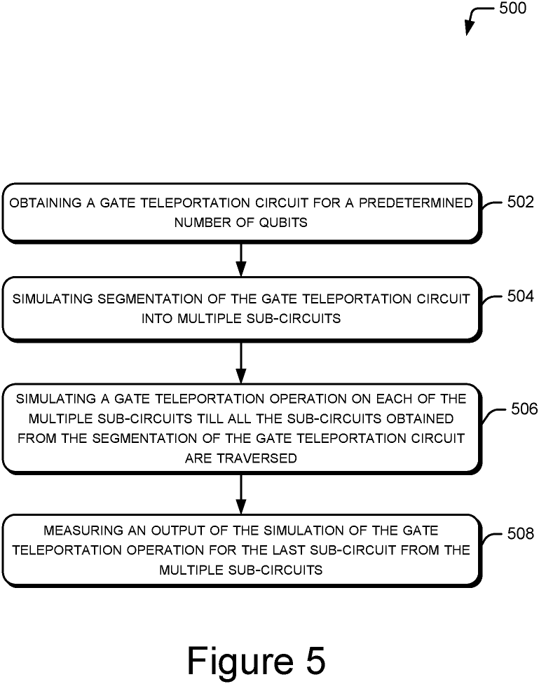

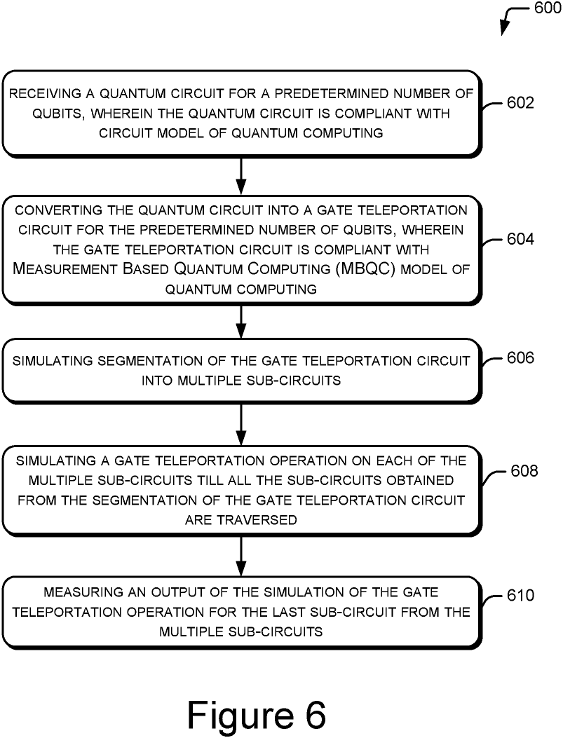

FIG. 5 and FIG. 6 illustrate methods 500 and 600 for implementing a simulator for quantum computing systems, in accordance with examples of the present subject matter. Although the methods 500 and 600 may be implemented in a variety of devices, but for the ease of explanation, the description of the methods 500 and 600 is provided in reference to the above-described simulator 100. The order in which the methods 500 and 600 are described is not intended to be construed as a limitation, and any number of the described method blocks may be combined in any order to implement the methods 500 and 600, or an alternative method.

It may be understood that blocks of the methods 500 and 600 may be performed in the simulator 100. The blocks of the methods 500 and 600 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

At block 502, a gate teleportation circuit for a predetermined number of qubits may be obtained, where the gate teleportation circuit may be compliant with MBQC model. In said example, the gate teleportation circuit may be obtained by a circuit reception engine 102 of the simulator 100.

At block 504, segmentation of the gate teleportation circuit into multiple sub-circuits may be simulated. In an example, segmentation of the gate teleportation circuit into multiple sub-circuits may be simulated based on the predetermined number of qubits . In an example, if the number of qubits included in the gate teleportation circuit is equal to ‘2ⁿ’, the gate teleportation circuit may simulate segmentation of the gate teleportation circuit into multiple sub-circuits, with each of the multiple sub-circuits having ‘n’ qubits. In another example, if the number of qubits included in the gate teleportation circuit is greater than ‘2ⁿ’ but less than 2ⁿ⁺¹, the circuit segmentation engine 110 may simulate segmentation of the gate teleportation circuit into multiple sub-circuits, with each of the multiple sub-circuits having ‘n+1’ qubits. The segmentation of the gate teleportation circuit into multiple sub-circuits may be simulated by a circuit segmentation engine 110 of the simulator 100.

At block 506, a gate teleportation operation may be simulated on each of the multiple sub-circuits till all the sub-circuits obtained from the segmentation of the gate teleportation circuit are traversed. In an example, the gate teleportation operation for each of the multiple sub-circuits may be simulated based on an output of a gate teleportation operation performed on a previous sub-circuits and the qubits included in each of the multiple sub-circuits. In an example, the gate teleportation operation may be simulated on each of the multiple sub-circuits by the gate teleportation engine 112.

At block 508, an output of simulation of the gate teleportation operation for the last sub-circuit from the multiple sub-circuits may be measured. In an example, the output of simulation of the gate teleportation operation performed on the last sub-circuit may be obtained by the other engine 114.

FIG. 6 illustrates a method 600 for implementing a simulator for quantum computing systems, in accordance with examples of the present subject matter.

At block 602, a quantum circuit for a predetermined number of qubits may be received, where the quantum circuit may be compliant with circuit model of quantum computing. In an example, the quantum circuit for the predetermined number of qubits may be received by the circuit reception engine 102 of the simulator 100.

At block 604, the quantum circuit may be converted into a gate teleportation circuit, where the gate teleportation circuit may be compliant with MBQC model. In an example, the quantum circuit may be converted into a gate teleportation circuit by the circuit conversion engine 210 of the simulator 100.

At block 606, segmentation of the gate teleportation circuit into multiple sub-circuits may be simulated. In an example, segmentation of the gate teleportation circuit into multiple sub-circuits may be simulated based on the predetermined number of qubits . In an example, if the number of qubits included in the gate teleportation circuit is equal to ‘2ⁿ’, the gate teleportation circuit may simulate segmentation of the gate teleportation circuit into multiple sub-circuits, with each of the multiple sub-circuits having ‘n’ qubits. In another example, if the number of qubits included in the gate teleportation circuit is greater than ‘2ⁿ’ but less than 2ⁿ⁺¹, the circuit segmentation engine 110 may simulate segmentation of the gate teleportation circuit into multiple sub-circuits, with each of the multiple sub-circuits having ‘n+1’ qubits. The segmentation of the gate teleportation circuit into multiple sub-circuits may be simulated by a circuit segmentation engine 110 of the simulator 100.

At block 608, a gate teleportation operation may be simulated on each of the multiple sub-circuits till all the sub-circuits obtained from the segmentation of the gate teleportation circuit are traversed. In an example, the gate teleportation operation for each of the multiple sub-circuits may be simulated based on an output of a gate teleportation operation performed on a previous sub-circuits and the qubits included in each of the multiple sub-circuits. In an example, the gate teleportation operation may be simulated on each of the multiple sub-circuits by the gate teleportation engine 112.

At block 610, an output of simulation of the gate teleportation operation for the last sub-circuit from the multiple sub-circuits may be measured. In an example, the output of simulation of the gate teleportation operation performed on the last sub-circuit may be obtained by the other engine 114.

Although examples of the present subject matter have been described in language specific to methods and/or structural features, it is to be understood that the present subject matter is not limited to the specific methods or features described. Rather, the methods and specific features are disclosed and explained as examples of the present subject matter.

We claim:

1. A method comprising:
obtaining a gate teleportation circuit for a predetermined number of qubits, wherein the gate teleportation circuit is to transfer an unknown quantum state of a qubit to another qubit in a quantum computing model, and wherein the gate teleportation circuit is compliant with Measurement Based Quantum Computing (MBQC) model of quantum computing;
simulating segmentation of the gate teleportation circuit into a plurality of sub-circuits based on the predetermined number of qubits, wherein each of the plurality of sub-circuits comprises at least one qubit;
simulating a gate teleportation operation on each of the plurality of sub-circuits sequentially, wherein the gate teleportation operation on each of the plurality of sub-circuits is simulated based on the at least one qubit of a given sub-circuit and an output of a gate teleportation operation simulated on a sub-circuit which is previous to the given sub-circuit; and
measuring an output of simulation on gate teleportation operation on a last sub-circuit from the plurality of sub-circuits.

2. The method as claimed in claim 1, further comprising:
receiving a quantum circuit for the predetermined number of qubits, wherein the quantum circuit is compliant with circuit model of the quantum computing; and
converting the quantum circuit into the gate teleportation circuit.

3. The method as claimed in claim 1, wherein each of the plurality of sub-circuits comprises ‘n’ qubits when the predetermined number of qubits is 2ⁿ.

4. The method as claimed in claim 1, wherein each of the plurality of sub-circuits comprises ‘n+1’ qubits when the predetermined number of qubits is more than 2ⁿ and less than 2ⁿ⁺¹.

5. A simulator for a quantum computing system comprising:
a circuit reception engine to obtain a gate teleportation circuit for a predetermined number of qubits, wherein the gate teleportation circuit is utilized for transferring an unknown quantum state of a qubit to another qubit in a quantum computing model, and wherein the gate teleportation circuit is complaint with Measurement Based Quantum Computing (MBQC) model of quantum computing;
a circuit segmentation engine coupled to the circuit reception engine to simulate segmentation of the gate teleportation circuit into a plurality of sub-circuits based on the predetermined number of qubits, wherein each of the plurality of sub-circuits comprises at least one qubit; and
a gate teleportation engine coupled to the circuit segmentation engine to:
simulate a gate teleportation operation on each of the plurality of sub-circuits sequentially, wherein the gate teleportation operation on each of the plurality of sub-circuits is simulated based on an at least one qubit of a given sub-circuit and an output of a gate teleportation operation simulated on a sub-circuit which is previous to the given sub-circuit; and
measure an output of the gate teleportation operation on a last sub-circuit from the plurality of sub-circuits.

6. The simulator as claimed in claim 5, further comprising a circuit conversion engine to:
receive a quantum circuit for the predetermined number of qubits, wherein the quantum circuit is complaint with circuit model of the quantum computing; and
convert the quantum circuit into the gate teleportation circuit.

7. The simulator as claimed in claim 5, wherein each of the plurality of sub-circuits comprises ‘n’ qubits when the predetermined number of qubits is 2ⁿ.

8. The simulator as claimed in claim 5, wherein each of the plurality of sub-circuits comprises ‘n+1’ qubits when the predetermined number of qubits is more than 2ⁿ and less than 2ⁿ⁺¹.
